(19) United States
(12) Patent Application Publication
(10) Pub. No.: US 2001/0025929 A1
(43) Pub. Date: Oct. 4, 2001

(54) Secondary electron filtering method, defect detection method and device manufacturing method using the same method

(76) Inventor: Mamoru Nakasuji, Yokohama-shi (JP)

Correspondence Address: Mamoru Nakasuji, 2-15-11, Serigaya-chou, Kounan-ku, Yokohamashi, Kanagawa-ken, JP

(21) Appl. No.: 09/818,226

(22) Filed: Mar. 28, 2001

(30) Foreign Application Priority Data
Mar. 31, 2000 (JP) 2000-135249

(51) Int. Cl. G01K 1/08; H01J 3/14; H01J 3/26

(52) U.S. Cl. 250/399

(57) ABSTRACT

If a conventional mesh filter is used for a voltage contrast measurement on a specimen surface, aberrations that is difficult to correct in a primary electron (PE) beam are generated and then it is difficult to obtain a fine focused beam.

An axially symmetric electrode is placed between the secondary electron (SE) detector and the specimen. Through an adjustment for an applied voltage in the electrode, a potential on the optical axis above the specimen is adjusted so that a passage or non-passage of the SEs can be controlled.

### FIELD OF THE INVENTION

This invention pertains to a secondary electron (SE) filtering method, in which a finely focused charged particle beam is scanned on a specimen surface and a defect detection or a critical dimension measurement are done.

This invention also pertains to a device manufacturing method using the defect detection method and the critical dimension measurement method.

### BACKGROUND OF THE INVENTION

There has been put a retarding field type objective lens, because it can reduce an axial chromatic and a spherical aberrations dramatically.

There has been proposed a SE filter that a semi-spherical mesh electrode is placed between the objective tens and the specimen surface, and a voltage applied on this electrode is adjusted.

A voltage contrast measurement method on the wafer using such a mesh filter and a strobe-SEM in which pulsed electron beam is irradiated on the specimen and a local pattern potential for on operating device is measured with high time resolution, are well known.

For the conventional retarding field objective lens, as all emitted SEs from the specimen are detected by SE detector independent on the specimen local pattern potential, it is difficult to obtain a voltage contrast on the specimen.

Moreover, for the conventional mesh filter, when a primary electron (PE) is scanned on the specimen, the PE trajectory that pass near the mesh wire, is bent and then some distortion and blur are generated. Therefore, it is difficult to obtain a fine beam and to obtain a precise scanning. Especially, when such a mesh filter is placed in the retarding field, the influence of the distortion and beam blur is large.

An aim of this invention is to obtain a SE filtering method, in which can be used in the retarding field objective lens and the beam blur and distortion do not increased by using these SE filtering method. Another aims of this invention are to offer a defect detection method using such a SE filtering method and to offer a device manufacturing method using such a filtering method.

### SUMMARY OF THE INVENTION

It is a purpose of the invention to provide a SE filtering method, in which a high precision voltage contrast measurement can be done and a high reliable defect detection can be done.

It is another purpose of the invention to provide a device manufacturing method, in which a high yield can be obtained.

The SE filtering method of the first embodiment of this invention comprises the step of:

(a) a charged particle beam source, SE detector, an objective lens and a specimen are arranged,

(b) an axially symmetrical electrode is deposited between the SE detector and the specimen surface,

(c) an applied voltage to the electrode is adjusted so that at the specified position between the specimen and the SE detector, an axial potential can select the passage or non-passage for the SE that are emitted from the specimen.

A defect detection method of the second embodiment of this invention comprises the step of:

(a) a charged particle beam source, SE detector, an objective lens and a specimen are arranged,

(b) an axially symmetrical electrode is deposited between the SE detector and the specimen surface,

(c) an applied voltage to the electrode is adjusted so that the SE detection yield from the pattern aera with lower potential is high and that from the pattern area with higher potential is low, and

(d) defect in the specimen are detected, when the signal level from the pattern area that must be low potential is low, or the signal level from the pattern area that must be high potential is high.

A critical dimension measurement method of the third embodiment of this invention comprising steps of:

(a) a charged particle beam source, SE detector, an objective lens and a specimen are arranged,

(b) an axially symmetrical electrode is deposited between the SE detector and the specimen surface,

(c) the axially symmetrical electrode is applied sufficiently high voltage so that almost all the SEs from the specimen pass through this filter,

(d) a pattern line width measurement is done through the signal from the topography or the material change on the specimen.

### BRIEF DESCRIPTION OF THE DRAWINGS

FIG. 1 is an typical cross section for a charged particle beam system with a SE filter of this invention.

FIG. 2 is an explanation chart for a voltage contrast for the typical SE filter in this invention.

FIG. 3 is a flow chart for a device manufacturing method of this invention.

### DETAILED DESCRIPTION OF A PREFERRED EMBODIMENT

The following are explanation with the drawing refereed to.

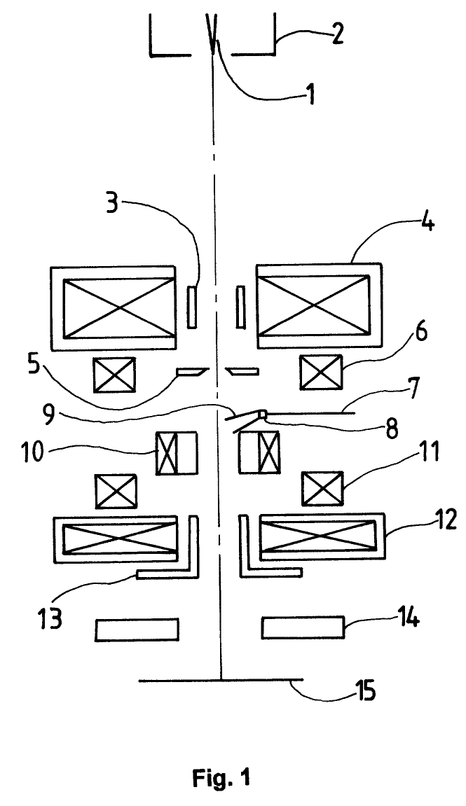

FIG. 1 shows a first embodiment of this invention. A high brightness electron beam emitted from an thermal field emitter deposited center of an electron gun 2 is focused by a condenser lens 4, and forms a crossover in the ExB separator 10.

The electron beam is raster scanned on the specimen by two stage deflectors 6 and 11. The deflectors 6 and 11 are both magnetic deflectors and can scan 1 mm square in x and y direction.

The crossover that formed in the deflection center of the ExB separator 10 is focused on the specimen 15 by the objective lens 12. As the cathode have a potential of −500 V, the landing energy is 500 eV for a grounded specimen. The electrode 13 forms the retarding field and is given 10 kV voltage.

Between the objective lens and the specimen, the axial symmetrical electrode 14 of this invention is placed.

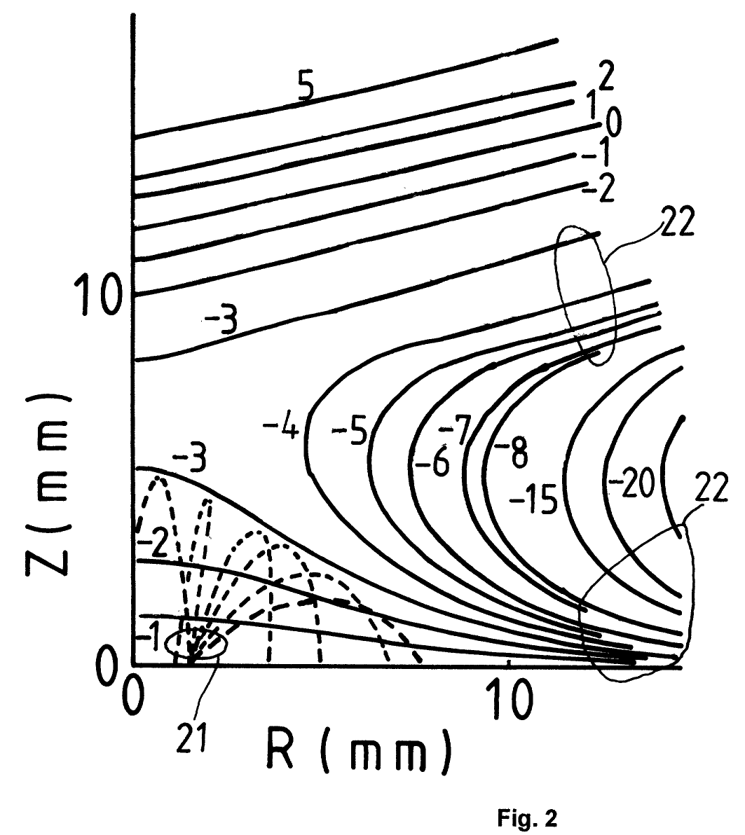

FIG. 2 shows how a voltage contrast is obtained by this invented SE filter. When the electrode 13 for the retarding field, the SE filter electrode 14 and the specimen 15 are given 10 kV, −30 V, and 0 V, respectively, equipotential lines 22 and SE trajectories 21 are shown in this figure.

In FIG. 2 when the SE filter electrode 14 is given a lower voltage than the specimen surface, a negative axial potential is formed above the specimen surface. For example, if a −3V of the axial potential is performed as in FIG. 2, SE with smaller than 3 eV of initial energy from a pattern with 0 V biased cannot pass through this potential barrier, be drove back as shown in FIG. 2 to the specimen surface, and does not arrive to the detector. However, the SEs emitted from the specimen pattern with −3 V biased, still have a kinetic energy at the barrier, pass through this barrier and the objective lens, deviate from the optical axis at the ExB separator, and are detected by the SE detection system 7, 8 and 9. Where 7 is an optical fiber, which is connected to a PMT, 8 is a scintillator, and 9 is a SE collector. That is, SE detection yield varies dependent on the specimen patterns potential, and the voltage contrast can be obtained.

The SEs emitted from a position far from the optical axis tend to reach to the potential barrier at some place far from the optical axis. As the minimum value of the potential barrier become deeper depending on the distance from the optical axis as shown in FIG. 2, the potential barrier for the SEs become higher and SEs become more difficult to be detect. To correct this effect, it is necessary to adjust dynamically electrode 13 voltage depending on the scanning deflection. As an another means, simply, some offset voltage can be added to the signal level. For example one picture image is displayed on the CRT monitor some offset values as a function of the deflection is measured, so that a pattern brightness for the same pattern potential become the same brightness, and measured offset values are kept in a table. Also in the case where the potential given to the filter is varies dynamically, the same calibration may be possible.

The second embodiment of this invention is as follows. In FIG. 1, a pulsed electron beam is formed by the combination of a blanking deflector 3 and a blanking aperture 5, the specimen is scanned by this pulsed electron beam and a strobe SEM, in which each pattern potential on an operating device are measured with highly time resolution, is possible. In this case, it is better that the crossover image formed by the condenser lens 4 is formed on the crossover aperture 5 than the deflection center of the ExB separator, because smaller blanking voltage can make on and off the electron beam.

When a non-retarding field type objective lens is used, it is better to place this type of filter electrode 14 above the objective lens, because shorter focal length and the smaller axial chromatic aberration can be obtained. In that case, SEs with smaller energy pass through the filter and then the better voltage resolution can be obtained.

A defect detection is done as follows. In FIG. 1, the specimen surface 15 is scanned two dimensionally using the deflectors 6 and 11, SEs generated from the pattern electrode on the specimen are detected by the detection system 7, 8 and 9. The one and the other pattern area on the specimen are given 0 and 3 V potentials, respectively, the potential for the SE filter 14 is given so that the pattern area with 0 V potential is bright and the pattern area with 3 V potential is dark. For this adjustment, the device is operated, and the defects in the device are detected as the signal level from the pattern area that must be 0 V is dark or the signal level from the pattern that must be 3 V is bright.

The another embodiment of this invention is as follows, the SE filter in FIG. 1 is applied sufficiently high voltage so that all the SEs from the specimen pass through this SE filter. The pattern on the specimen are not applied voltage, the pattern line width measurement can be done through the signal from the topography and the material change on the specimen is detected with good S/N ratio. For this case it is better that the retarding field is applied between the objective lens and the specimen.

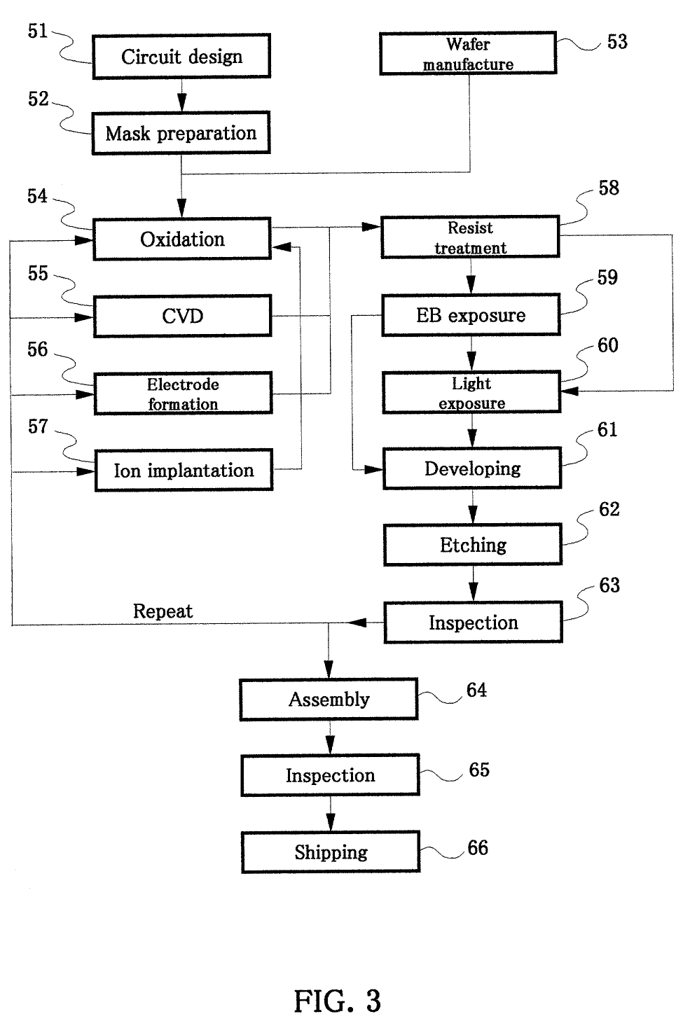

Following is the explanation for a semiconductor device manufacturing method in this invention. FIG. 3 is a flow chart of steps in a manufacturing a semiconductor device such as a semiconductor chip, a display panel, or CCD, for example. In step 51, the circuit for the device is designed. In step 52, reticles for the circuits are manufactured. In step 53, a wafer is manufactured from a material such as silicon.

Steps 54-63 are directed to wafer-processing steps, especially “pre-process” steps. In the pre-process steps, the circuit pattern defined on the reticle is transferred onto a wafer by microlithography. Step 64 is an assembly step in which the wafer that has been passed through steps 54-63 is formed into semiconductor chips. This step can include, e.g., assembling the devices and packaging. Step 65 is an inspection step in which any of various operability and qualification tests of the device produced in step 64 are conducted. Afterward, devices that successfully pass step 65 are finished, packaged, and shipped (step 66).

Steps 54-63 also provide representative details of wafer processing. Step 54 is an oxidation step for oxidizing the surface of a wafer. Step 55 involves chemical vapor deposition (CVD) for forming an insulating film on the wafer surface. Step 56 is an electrode-forming step for forming electrodes on the wafer. Step 57 is an ion-implantation step for implanting impurity into the wafer. Step 58 involves application of an exposure sensitive resist to the wafer. Step 59 involves exposing the resist by CPB microlithography, using the reticle produced in step 52, so as to imprint the resist with the reticle pattern, as described elsewhere herein. In step 60, a circuit pattern is exposed onto the wafer using optical microlithography. Although this figure shows both CPB and optical microlithography being performed, it alternatively is possible to transfer the entire pattern using only CPB microlithography. Step 61 involves developing the exposed resist on the wafer. Step 62 involves etching the wafer to remove material from areas where developed resist is absent. Step 63 involves wafer inspection process in which defect detection ets., are done. By repeating steps 54-63 such a numbers as required layer numbers, circuit patterns as defined by successive reticles are superposedly formed on the wafer and the semiconductor devices which act as designed characteristics are manufactured.

When the secondary electron filtering method in this invention is used at above wafer inspection process 63, the voltage contrast measurement can be obtained with high throughput, and then the semiconductor device can be formed with high yield.

As cleared from above explanation, in this invention as the axially symmetric SE filter can be available, the PE beam does not have aberrations difficult to correct, and then it can be focused finely and high resolution measurement can be done. As this filter can be used in the retarding field, then aberration in the PE can be reduced dramatically.

Finally, the filters in this invention combined with the electrostatic lenses, electrostatic deflectors, forms small outer radius optical system. Many of this type electron optics are arranged on a wafer, a high throughput measurement or defect detection can be done.

Whereas the invention has been described in connection with a representative embodiments, it will be understood that the invention is not limited to such embodiments. On the contrary, the invention is intended to encompass all modifications, alternations, and equivalents as may be encompassed by the spirit and scope of the invention, as defined by the appended claims.

Having thus described the invention, what is claimed as new and desirable to be secured by Letters Patent is as follows:

1. A SE filtering method comprising steps of:
(a) a charged particle beam source, SE detector, an objective lens and a specimen are arranged,
(b) an axially symmetrical electrode is deposited between the SE detector and the specimen surface,
(c) an applied voltage to the electrode is adjusted so that at the specified position between the specimen and the SE detector, an axial potential can select the passage or non-passage for the SEs that are emitted from the specimen.

2. The SE filtering method of claim 1, wherein
a retarding field for the primary electron beam is formed between said objective lens and the specimen, and
said electrode is deposited between the objective lens and the specimen.

3. The SE filtering method of claim 1, wherein
deflectors for scanning and blanking, and a blanking aperture are prepared,
pulsed electron beam is exposed on the specimen, and
a voltage contrast in the small pattern area is measured with a high time resolution.

4. The SE filtering method of claim 1, wherein
an applied voltage for the axial symmetric electrode is varied dynamically, depending on the scanning signal on the deflector.

5. The SE filtering method of claim 1, wherein
an offset value on the SE signal level is dynamically varied, depending on the scanning signal on the deflector.

6. The SE filtering method of claim 1, wherein
said axially symmetrical electrode is placed between the objective lens and the detector, and
a non-retarding field type objective lens is used.

7. The SE filtering method of claim 1, wherein
the lenses are electrostatic lenses, and plural electron optics are arranged on a wafer.

8. A defect detection method comprising steps of:
(a) a charged particle beam source, SE detector, an objective lens and a specimen are arranged,
(b) an axially symmetrical electrode is deposited between the SE detector and the specimen surface,
(c) an applied voltage to the electrode is adjusted so that the SE detection yield from the pattern electrode with lower potential is high and that from the pattern area with higher potential is low, and
(d) defect in the specimen are detected, when the signal level from the pattern that must be low potential is low, or the signal level from the pattern that must be high potential is high.

9. The defect detecting method of claim 8, wherein
a retarding field for the primary electron beam is formed between said objective lens and the specimen, and said electrode is deposited between the objective lens and the specimen.

10. The defect detecting method of claim 8, wherein
a deflectors for scanning and blanking, and a blanking aperture are prepared,
pulsed electron beam is exposed on the specimen, and
a voltage contrast in the small pattern area is measured with a high time resolution.

11. The defect detecting method of claim 8, wherein
an offset value on the SE signal level is dynamically varied, depending on the scanning signal on the deflector.

12. The defect detecting method of claim 8, wherein
an offset value on the SE signal level is dynamically varied, depending on the scanning signal on the deflector.

13. The defect detecting method of claim 8, wherein
said axially symmetrical electrode is placed between the objective lens and the SE detector, and
a non-retarding field type objective lens is used.

14. The defect detecting method of claim 8, wherein
the lenses are electrostatic lenses, and plural electron optics are arranged on a wafer.

15. A critical dimension measurement method comprising steps of:
(a) a charged particle beam source, SE detector, an objective lens and a specimen are arranged,
(b) an axially symmetrical electrode is deposited between the SE detector and the specimen surface,
(c) the axially symmetrical electrode is applied sufficiently high voltage so that almost all the SEs from the specimen pass through this filter,
(d) a pattern line width measurement is done through the signal from the topography or the material change on the specimen.

16. The critical dimension measurement method of claim 15, wherein
a retarding field is applied between the objective lens and the specimen.

17. The critical dimension measurement method of claim 15, wherein
the lenses are electrostatic lenses, and plural electron optics are arranged on a wafer.

18. A device manufacturing method comprising steps of:
wafers are observed status using the method of claim 1 at least one of the wafer-processing steps.

19. A device manufacturing method comprising steps of:
wafers are observed status using the method of claim 8 at least one of the wafer-processing steps.

20. A device manufacturing method comprising steps of:
a pattern critical dimension on the wafers are measured using the method of claim 15 at least one of the wafer-processing steps.
